(19) United States
(12) Patent Application Publication
(10) Pub. No.: US 2008/0175303 A1
(43) Pub. Date: Jul. 24, 2008

(54) Thermocouple Assembly And Method Of Use

(75) Inventor: Bernard Robbins, Altrincham, Cheshire (GB)

Correspondence Address: Thomas J Clinton;Vesuvius USA Corporation, RIDC Park West, 250 Park West Drive, Pittsburgh, PA, 15275, US

(73) Assignee: VESUVIUS CRUCIBLE COMPANY, Wilmington, DE (US)

(21) Appl. No.: 11/793,877

(22) PCT Filed: Dec. 20, 2005
(86) PCT No.: PCT/EP2005/013693

§ 371 Date: Jun. 21, 2007

(30) Foreign Application Priority Data
Dec. 21, 2004 (EP) 04447285.0

(51) Int. Cl. G01K 7/00

(52) U.S. Cl. 374/179

(57) ABSTRACT

A thermocouple assembly for the continuous measurement of the temperature of a molten phase contains first and second ceramic elements contacting each other at a first junction and forming thereby a first thermocouple, a second thermocouple formed of two different conducting elements contacting each other at a second junction located on the first ceramic element and a third thermocouple formed of two different contacting elements contacting each other at a third junction located on the second ceramic element. Both positive legs or both negative legs of the second and third thermocouples are connected to a first measuring device. Both legs of the second and third thermocouple are connected respectively to a second and third measuring device as well as to a process for the measurement of the temperature of a molten phase.

### FIELD OF THE INVENTION

The present invention concerns a thermocouple assembly for the measurement of the temperature of a molten phase (or other high temperature applications) and to a method for the measurement of the temperature of a molten phase (or other high temperature applications) using the said thermocouple assembly.

### BACKGROUND OF THE INVENTION

It is known that dissimilar materials, when joined produce an electromotive force by the Seebeck effect in relation to the temperature of the junction between the materials. Thermocouples constituted of metals are known and have been widely used for decades. Unfortunately, the metals used for these thermocouples have a tendency to oxidize or to be chemically attacked during use so that their accuracy is not guaranteed over extended periods. It has already been described that certain non-metallic materials, for example ceramics, may also produce an electromotive force in relation to their temperature. Ceramics do not suffer the above disadvantages.

GB 2,288,908 or U.S. Pat. No. 4,450,314 for example disclose ceramic thermocouple assemblies for the measurement of the temperature of a molten phase and other high temperature applications. These thermocouple assemblies consist of first and second ceramic elements contacting each other at a junction wherein one of the ceramic elements is urged against the other.

It has now been realized that, although this ceramic assembly was already a significant step forward in the art, the accuracy of the temperature measurement still needs to improve for some particular applications. For certain very demanding applications like continuous casting of steel, hot pressing or manufacture of a glass ribbon at the surface of a tin bath, it is indeed required to monitor continuously and accurately temperatures as high as 2000° C.

The main problem arises from the fact that the cold junctions at the “cold ends” of the first and second ceramic elements, where electrical measurements are made, can themselves produce electromotive forces of sufficient magnitude to introduce significant errors in the measurement process and these errors increase with increasing junction temperature. Since constraints are indeed imposed on the manufacture and costs, long ceramic thermocouples cannot be fabricated. Consequently, the “cold ends” are relatively close to the hot junction and are also subject to relatively high temperatures. Thereby, significant electromotive forces are also generated at the “cold ends” ceramic/metal junctions. These electromotive forces, which will alter the reading at the electromotive force readout meter, are variable with the temperature so that an accurate continuous measurement of the temperature at the hot junction cannot be determined. For example, it has been measured that for a silicon carbide/molybdenum disilicide thermocouple operated at only 150° C., an increase of 10° C. at the “cold ends” would result in a final temperature determination lower by around 10° C. In the scope of the present application, the expression “cold ends” designates the ends of the first and second ceramic elements which are opposite to their junction (hot junction).

Cold junction compensation has already been proposed in the art. Various attempts have been made such as cooling of the cold ends (unfortunately, cooling of the cold ends may also affect the temperature at the hot end or can simply be impractical), use of electronic circuits generating an electromotive force nullifying the electromotive forces generated at the “cold ends” (this however involves complex structure and is not reliable in the case of a ceramic thermocouple assembly), etc. Practically, none of the proposed solutions has permitted to significantly improve the accuracy of a ceramic thermocouple assembly.

There is therefore a need to improve the accuracy of ceramic thermocouple assemblies using a simple, reliable (independent from the temperature) and practical method.

### SUMMARY OF THE INVENTION

It has been found that for a thermocouple assembly for the measurement of a temperature comprising first and second ceramic elements contacting each other at a first junction and forming thereby a first thermocouple, this objective can be reached when the assembly also comprises a second thermocouple formed of two different conducting elements (generally metallic conductors) contacting each other at a second junction located on the first ceramic element and a third thermocouple formed of two different conducting elements (generally metallic conductors) contacting each other at a third junction located on the second ceramic element, wherein both positive legs or both negative legs of the second and third thermocouples are connected to a first measuring device, while both legs of the second and third thermocouple are connected respectively to a second and third measuring device.

The inventors have indeed realised that it is impossible to accurately compensate by electronic means only the electromotive force generated at these cold junctions for a broad range of temperatures and have therefore decided to measure or calculate them exactly and then add or subtract these electromotive forces to calculate the true electromotive force at the hot junction.

According to a first and preferred embodiment of the invention, the first measuring device is an electromotive force readout meter while the second and third measuring devices are thermocouple temperature measuring devices. In that case, the electromotive forces generated at said cold junctions can be calculated by comparing the measured temperature values to experimental data (calibration curve) or theoretical data (polynomial curve).

In another embodiment of the present invention, the first, second and third measuring devices are electromotive force readout meters. Obviously, at the junctions between the two legs of the second and third thermocouples with the connectors of their respective measuring device, unwanted electromotive forces are also generated. Advantageously, the second and third electromotive force readout meters comprise compensating means (for example electronic circuits) for these electromotive forces.

Preferably, the conducting elements of both thermocouples as well as the connectors of their respective electromotive force readout meters are metallic conductors so that conventional cold junction compensating means can be used.

Preferably, the first and second ceramic elements are made from materials selected from the group consisting of silicon carbide, alumina-graphite based compositions, titanium nitride, molybdenum disilicide, boron carbide, titanium dioxide, carbon and stabilized zirconia alone or in admixture. According to an advantageous embodiment, the first ceramic element comprises molybdenum disilicide and the second ceramic element comprises silicon carbide or titanium nitride.

According to another advantageous embodiment, the first ceramic element comprises silicon carbide or titanium nitride and the second ceramic element comprises an alumina-graphite based composition. Suitable such alumina-graphite based compositions comprise generally 40-70 wt. % alumina, 20-40 wt. % graphite, 2-10 wt. % carbon based binder and the remainder of other refractory oxides such as magnesia, zirconia, silica, etc, the compositions disclosed in U.S. Pat. No. 4,721,533 are suitable to this end.

According to a preferred embodiment of the present invention, the first ceramic element forms an inner leg and the second ceramic element forms an outer sheath. Thereby, the second ceramic element protects the first ceramic element from attacks by the molten phase. In this case, the second ceramic element is generally selected to be suitable to resist the molten phase attacks for a certain time, very suitable materials in this case are the alumina-graphite based compositions.

In the case of this embodiment, the assembly preferably further comprises an electrically insulating sleeve (preferably constituted of alumina) around the inner leg. This provides electrical insulation and helps to provide rod retention and cushioning from vibration.

In certain cases, it can also be advantageous to have a further sleeve located around the sleeve insulating the inner leg to prevent excessive rod movement (in certain applications only).

According to a particular embodiment of the invention, the thermocouple assembly can itself be engaged into a ceramic protective sleeve, for example as described in U.S. Pat. No. 4,721,533. In such a case, it is advantageous to provide an electrically insulating coating on the outer walls of the second ceramic element or on the inner walls of the protective sleeve. Alumina based coatings are particularly suitable for such applications. The sleeve itself can be formed as a part of a conventional casting piece such as a stopper, a submerged entry nozzle, an inner nozzle, a refractory plate, etc. as disclosed in GB-A-2263427.

According to another aspect, the invention relates to a method for the measurement of a temperature comprising

a) introducing a thermocouple assembly according to the present invention into a hot environment, the first junction being positioned at or near the point the temperature of which has to be measured,
b) calculating or measuring the values of the first, second and third electromotive force with the first, second and third measuring devices;
c) calculating the true electromotive force generated at the first (hot) junction by adding or subtracting the calculated or measured electromotive forces generated at the cold junctions;
d) converting the true electromotive force calculated in step c) into a temperature.

For example, if both positive legs of the second and third thermocouples are connected to an electromotive force readout meter, the total electromotive force read on the meter will be equal to the electromotive force generated at the first (hot) junction plus the electromotive force generated at the cold end of the first ceramic element (as calculated or measured using the second measuring device) minus the electromotive force generated at the cold end of the second ceramic element (as calculated or measured using the third measuring device).

The electromotive force generated at the first (hot) junction can thereby be easily assessed and converted into a temperature, for example by comparing this value with a calibration curve or a polynomial expression.

The repetition of steps b) to d) will provide a continuous measurement of the temperature.

### BRIEF DESCRIPTION OF THE DRAWINGS

With a view to better define the invention, it will now be described with reference to the enclosed figures; wherein

FIG. 1 depicts a schematic thermocouple assembly according to the invention and

FIG. 2 is a diagram showing the temperature determined with the thermocouple assembly of FIG. 1 using the above described method.

### DETAILED DESCRIPTION OF THE INVENTION

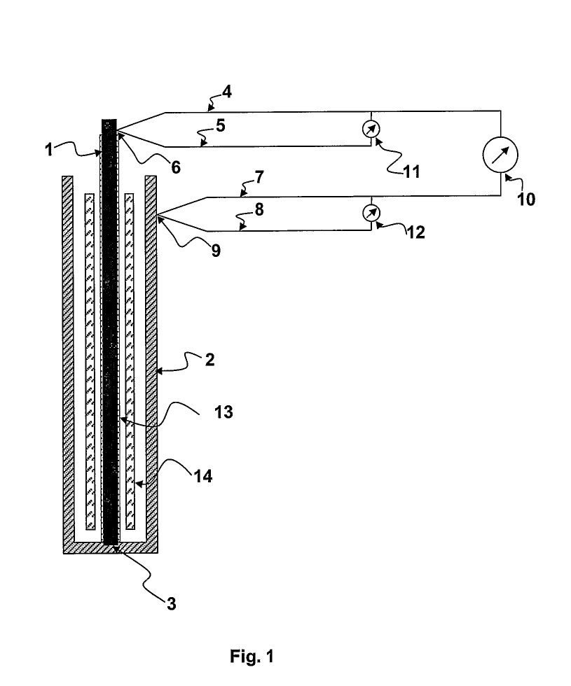

FIG. 1 schematically shows thus a thermocouple assembly for the measurement of the temperature of a molten phase according to the invention. It is constituted of first and second ceramic elements (1,2) contacting each other at a first junction (3) and forming thereby a first thermocouple. In use, the junction (3) is positioned at or under the level of the molten phase. A second thermocouple formed of two different conducting elements (4,5), preferably metallic conductors, contacting each other at a second junction (6) is located on the first ceramic element (1) (preferably around the cold end of the first ceramic element (1)). A third thermocouple formed of two differing conducting elements (7,8), preferably metallic conductors, contacting each other at a third junction (9) is located on the second ceramic element (2), (preferably around the cold end of the second ceramic element (2)). Both positive legs (4,7) or both negative legs (5,8) of the second and third thermocouples are connected to a first measuring device (10) (for example, an electromotive force readout meter). Both legs (4,5;7,8) of the second and third thermocouple are connected respectively to a second and third measuring device (11,12) (for example thermocouple temperature measuring devices).

Thereby, the electromotive forces generated at the cold ends are precisely measured and can be taken into account when determining the true electromotive force generated at the hot junction (3). The electromotive force generated at the hot junction can thereby be easily assessed and converted into a temperature, for example by comparing this value with a calibration curve or a polynomial expression. Quite surprisingly, such an installation can be achieved very simply by using both positive legs (4,7) or both negative legs (5,8) of the second and third thermocouples which are connected to a first electromotive force readout meter (10).

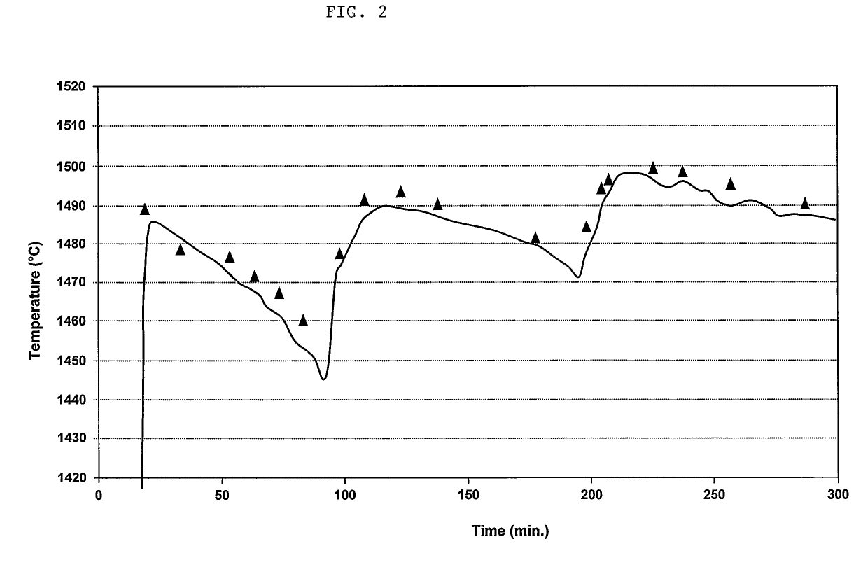

Visible in FIG. 2 is a curve depicting the temperature measured continuously with the thermocouple assembly according to the invention (continuous line) in a tundish used for the continuous casting of molten steel versus the casting time. The thermocouple assembly was inserted into an alumina-graphite protective sleeve as described in U.S. Pat. No. 4,721,533 and located near the stopper rod controlling the molten steel flow exiting from the tundish. At the beginning of the casting operations (opening of the ladle upstream from the tundish), the temperature rises rapidly. The response time of the thermocouple assembly was considered excellent. After about 90 minutes, the temperature of the tundish was about 1450° C.; this coincides with the end of the first ladle. A new ladle was brought into position and the temperature rose again with an excellent response time. After another 100 minutes, the second ladle was empty and the third ladle was brought into position and opened. During all of the casting operations, parallel temperature determination was performed using a standard thermocouple assembly of the type ACCUMETRIX sold by VESUVIUS USA CORPORATION as disclosed in U.S. Pat. No. 4,721,533 located at the opposite side of the tundish. The temperatures measured with the ACCUMETRIX sensor are depicted as triangles on FIG. 2. It can be seen that the temperatures measured with both systems correspond perfectly all along the casting operations. After use, the thermocouple assembly according to the invention was inspected and no damage was observed.

What is claimed is:

1-12. (canceled)

13. A thermocouple assembly for the measurement of a temperature comprising
first and second ceramic elements contacting each other at a first junction and forming thereby a first thermocouple;
a second thermocouple formed of two different conducting elements contacting each other at a second junction located on the first ceramic element; and
a third thermocouple formed of two different conducting elements contacting each other at a third junction located on the second ceramic element.

14. A thermocouple assembly according to claim 13 wherein the first measuring device is an electromotive force readout meter and the second and third measuring devices are thermocouple temperature measuring devices.

15. A thermocouple assembly according to claim 13 wherein the first, second and third measuring devices are electromotive force readout meters.

16. A thermocouple assembly according to claim 13 wherein the conducting elements are metallic conductors.

17. A thermocouple assembly according to claim 13, wherein the first and second ceramic elements are formed from a material selected from the group consisting of silicon carbide, titanium nitride, molybdenum disilicide, boron carbide, titanium dioxide, carbon, stabilized zirconia and alumina-graphite based compositions.

18. A thermocouple assembly according to claim 13, wherein the first ceramic element forms an inner leg and the second ceramic element forms an outer sheath.

19. A thermocouple assembly according to claim 18, wherein the outer sheath comprises an alumina-graphite based composition.

20. A thermocouple assembly according to claim 18, wherein the assembly further comprises an electrically insulating sleeve around the inner leg.

21. A thermocouple assembly according to claim 20, wherein the electrically insulating sleeve comprises alumina.

22. A thermocouple assembly according to claim 20, wherein a further sleeve is located around the sleeve insulating the inner leg.

23. Method for the measurement of the temperature of a molten phase comprising
a) introducing a thermocouple assembly according to claim 13 into a hot environment, the first junction being positioned at or near the point the temperature of which has to be measured;
b) calculating or measuring the values of the first, second and third electromotive force on the first, second and third measuring devices;
c) calculating the true electromotive force generated at the first junction; and
d) converting the true electromotive force calculated in step c) into a temperature.

24. Method according to claim 23 wherein step d) consists of comparing the true electromotive force calculated in step c) with a calibration curve or a polynomial expression to establish the temperature of the first junction.

25. Method according to claim 23 for the continuous measurement of a temperature comprising the repetition of steps b) to d).
